(19) United States
(12) Patent Application Publication
(10) Pub. No.: US 2008/0152392 A1
(43) Pub. Date: Jun. 26, 2008

(54) ELECTROPHOTOGRAPHIC IMAGE FORMING SYSTEM USING TRANSPARENT TONER

(75) Inventor: Ki-jae Do, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/781,983

(22) Filed: Jul. 24, 2007

(30) Foreign Application Priority Data
Dec. 26, 2006 (KR) 2006-134161

(51) Int. Cl. G03G 15/01

(52) U.S. Cl. 399/232

(57) ABSTRACT

An electrophotographic image forming apparatus includes a photosensitive body, an exposing unit forming an electrostatic latent image on the photosensitive body subsequent to the photosensitive body being charged to a uniform electric potential, and a developing unit in which a toner composition having color toner constituents and transparent toner constituents are provided to develop the electrostatic latent image on the photosensitive body. The color toner constituents and the transparent toner constituents are charged to opposite polarities with respect to an intermediate potential.

### CROSS-REFERENCE TO RELATED APPLICATIONS

This application claims the benefit of priority under 35 U.S.C. §119(a) of Korean Patent Application No. 10-2006-0134161, filed on Dec. 26, 2006, in the Korean Intellectual Property Office, the disclosure of which incorporated herein in its entirety by reference.

### BACKGROUND OF THE INVENTION

1. Field of the Invention

The present general inventive concept relates to image forming, and more particularly, to an electrophotographic image forming apparatus and concomitant image forming method using a transparent toner.

2. Description of the Related Art

Electrophotographic image forming apparatuses form an electrostatic latent image by scanning light onto a photosensitive body charged to a uniform electric potential, developing the electrostatic latent image with a predetermined color of toner and then transferring and fusing the developed image to and on a printing medium, thereby printing a desired image. In general, four colors of toners, such as yellow (Y), magenta (M), cyan (C), and black (B), are used in electrophotographic color image forming apparatuses, and four developing units are used to develop the electrostatic latent image formed on the photosensitive body with these four colors of toners.

A toner is manufactured based on a plastic resin and thus forms a glossy finish in the printed image. Consequently, a portion of a printed image to which the toner is attached has some gloss, but a background region of the printed image to which the toner is not attached has no gloss. In addition, a higher coverage (the ratio of an area to which the toner is attached to the area of the printing medium) of the printed image produces a higher gloss in the printed image. The gloss of the printed image affects the visual quality of the image. Certain image forming apparatuses feature a transparent image forming station to improve the gloss of a printed image by employing developing devices for developing electrostatic images with color toners and a developing device for developing an electrostatic image with a transparent toner.

### SUMMARY OF THE INVENTION

The present general inventive concept provides an electrophotographic image forming apparatus and concomitant method which develops a transparent toner image using a developing unit containing a color toner.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic image forming apparatus including a plurality of photosensitive bodies each charged to a uniform electric potential, a plurality of exposing units to form respective electrostatic latent images on the photosensitive bodies, a plurality of developing units to store respective color toners to develop the electrostatic latent images on the photosensitive bodies, and a transparent toner stored in one of the developing units together with one of the color toners and charged to an opposite polarity with respect to the color toners.

The foregoing and/or other aspects and utilities of the present general inventive concept are also achieved by providing an electrophotographic image forming apparatus including a photosensitive body to be charged to a uniform electric potential, a exposing unit to form an electrostatic latent image on the photosensitive body, a plurality of developing units in which different color toners are stored to develop the electrostatic latent image on the photosensitive body, a transfer medium to which a plurality of toner images sequentially developed on the photosensitive body are sequentially transferred, and a transparent toner stored in one of the developing units together with one of the color toners and charged to an opposite polarity with respect to a polarity of the color toners.

The foregoing and/or other aspects and utilities of the present general inventive concept are also achieved by providing a electrophotographic image forming apparatus comprising a photosensitive body to be charged to a uniform electric potential, an exposing unit to form an electrostatic latent image on the photosensitive body, a developing unit to develop the electrostatic latent image by providing thereto color toners and a transparent toner charged to an opposite polarity with respect to the color toners.

The foregoing and/or other aspects and utilities of the present general inventive concept are also achieved by providing an electrophotographic image forming apparatus including an electrostatically chargeable medium to receive a latent image thereon having a first region at a first electric potential and a second region at a second electric potential, and a toner composition having first toner constituents to carry a first electric charge and second toner constituents to carry a second electric charge, the first toner constituents being electrically attracted to the first region and the second toner constituents being attracted to the second region to form a developed image on the electrostatically chargeable medium.

The foregoing and/or other aspects and utilities of the present general inventive concept are also achieved by providing an electrophotographic image forming apparatus including a photosensitive medium to receive a latent image thereon having a first region and a third region at a first electric potential and a second region at a second electric potential, a first developer unit having stored therein a toner composition having first toner constituents to carry a first electric charge and second toner constituents to carry a second electric charge, the first toner constituents being electrically attracted to the first region and the second toner constituents being attracted to the second region, and a second developer unit having stored therein third toner constituents to be attracted to the third region to form a developed image on the electrostatically chargeable medium.

The foregoing and/or other aspects and utilities of the present general inventive concept are also achieved by providing a toner cartridge including a toner reservoir, and a toner composition retained in the toner reservoir and comprising first toner constituents to carry a first electric charge, and second toner constituents to carry a second electric charge.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an exemplary structure of a single pass color image forming apparatus, which is a type of an electrophotographic image forming apparatus according to an embodiment of the present general inventive concept;

FIG. 2 illustrates an electric potential of the surface of an exposed photosensitive drum;

FIG. 3 illustrates a detailed view of a portion in which a photosensitive drum and a developing roller in contact with each other;

FIG. 4 illustrates an exemplary pre-transfer charging unit;

FIG. 5 illustrates an example of a control circuit for tri-level exposure;

FIG. 6 illustrates an exemplary operation of developing a transparent toner using tri-level exposure;

FIG. 7 illustrates an exemplary structure of a single pass color image forming apparatus employing a direct transfer technique, which is a type of an electrophotographic image forming apparatus according to another embodiment of the present general inventive concept; and

FIG. 8 illustrates an exemplary structure of a multiple pass color image forming apparatus which is a type of an electrophotographic image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

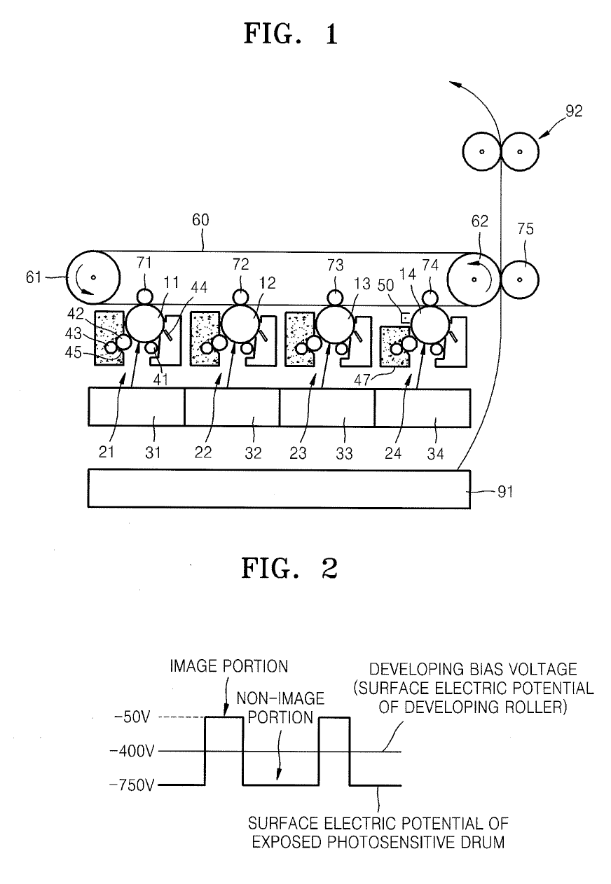

FIG. 1 illustrates an exemplary structure of an electrophotographic image forming apparatus according to an embodiment of the present general inventive concept. Referring to FIG. 1, the exemplary electrophotographic image forming apparatus according to the present embodiment is a single pass color image forming apparatus, which comprises four photosensitive drums 11, 12, 13, and 14, four exposing units 31, 32, 33, and 34, and four developing units 21, 22, 23, and 24, which are used to perform a color printing operation.

Color toners such as black (B), magenta (M), cyan (C), and yellow (Y) may be stored in the four developing units 21, 22, 23, and 24, respectively.

Each of the four photosensitive drums 11, 12, 13, and 14 is an example of a electrostatically chargeable body on which an electrostatic latent image may be formed, and may be implemented by, for example, an organic photosensitive body, an amorphous silicon photosensitive body having a long life span, or other media operable to be locally charged in regions thereof. Each of the four photosensitive drums 11, 12, 13, and 14 may be situated proximal to a corresponding one of the developing units 21, 22, 23, and 24 to cooperate therewith.

Each of charging rollers 41 is an example of a charging unit to charge each of the photosensitive drums 11, 12, 13, and 14 to a uniform electric potential. The charging rollers 41 may be in contact with the first and second photosensitive drums 11, 12, 13, and 14, respectively. A charging bias voltage may be applied to each of the charging rollers 41 and each of the charging rollers 41 may charge the surface of the photosensitive drums 11, 12, 13, and 14 to a uniform electric potential.

Each of the four exposing units 31, 32, 33, and 34 may scan light suitably modulated to convey image information of black (B), magenta (M), cyan (C), and yellow (Y) colors, respectively, onto the photosensitive drums 11, 12, 13, and 14 to thereby form respective electrostatic latent images. A laser scanning unit (LSU) that uses a laser diode as a light source may be used as each of the exposing units 31, 32, 33, and 34.

Each of the four developing units 21, 22, 23, and 24 may include a developing roller 42 and a supply roller 43. The exemplary supply roller 43 applies the toner stored in each of the developing units 21, 22, 23, and 24 to the developing roller 42. The developing units 21, 22, 23, and 24 may further comprise a regulating means 45, which regulates the amount of the toner attached to the surface of the developing roller 42 to so that a layer of toner having a uniform thickness is formed. For example, the regulating means 45 may be an elastic plate or a roller which is elastically in contact with the developing roller 42. In addition, the developing units 21, 22, 23, and 24 may further comprise at least one carrying means (not illustrated) to transport the toner stored in each of the developing units 21, 22, 23, and 24 into a region in which the developing roller 42 and the supply roller 43 face each other. In embodiments of the present general inventive concept where a contact developing technique is used, the developing rollers 42 are in contact with the photosensitive drums 11, 12, 13, and 14. A developing bias voltage, which is used to transfer respective toners stored in the developing units 21, 22, 23, and 24 to the electrostatic latent images on the photosensitive drums 11, 12, 13, and 14, is applied to each of the developing rollers 42. Due to the developing bias voltage, an electric potential difference between the developing rollers 42 and the electrostatic latent images is induced so that the toners are detached from the surface of the developing rollers 42 and are attracted to the electrostatic latent images. Thus, the electrostatic latent images are developed with the toners. Alternatively, in embodiments of the present general inventive concept where a non-contact developing technique is used, each of the developing rollers 42 is positioned to maintain a developing gap between each of the developing rollers 42 and the corresponding one of the photosensitive drums 11, 12, 13, and 14. A bias voltage produced from an AC current and a DC current may be used as a developing bias voltage. The present general inventive concept is not limited by the structure of the development units 21, 22, 23, 24 and, for purposes of description and not limitation, the exemplary embodiment will be described below in the context of the contact developing technique.

An intermediate transfer belt 60 is an example of an intermediate transfer medium to which toner images developed on the photosensitive drums 11, 12, 13, and 14 are temporarily transferred. The intermediate transfer belt 60 faces the photosensitive drums 11, 12, 13, and 14, and may be supported by support rollers 61 and 62. Each of first transfer rollers 71, 72, 73, and 74 faces each of the photosensitive drums 11, 12, 13, and 14 and the intermediate transfer belt 60 passes therebetween. A first transfer bias voltage, which is used to attract the toner images developed on the photosensitive drums 11, 12, 13, and 14 to the intermediate transfer belt 60, is applied to each of the first transfer rollers 71, 72, 73, and 74. For example, a conductive metal roller or a roller constructed by an elastic, semi-conductive rubber applied on a metal shaft may be used as each of the first transfer rollers 71, 72, 73, and 74.

A cleaning blade 44 may be used to eliminate the toner remaining on the surface of each of the photosensitive drums 11, 12, 13, and 14 after an intermediate transfer operation.

A second transfer roller 75 may be positioned to face the intermediate transfer belt 60. A printing medium maintained in, for example, a paper feeding cassette 91, may be transported by a carrying means (not illustrated) between the second transfer roller 75 and the intermediate transfer belt 60. A second transfer bias voltage, which is used to transfer the toner images attached to the intermediate transfer belt 60 to the printing medium, may be applied to the second transfer roller 75. A fusing unit 92 may then fuse the toner images onto the printing medium by applying heat and pressure to the printing medium.

The image forming apparatus according to the present general inventive concept is characterized in that a second toner, such as a transparent (T) toner, may share components of the developing unit corresponding to a first toner, such as any or all of the color toners of black (B), magenta (M), cyan (C), and yellow (Y). For example, the exemplary image forming apparatus according to the present general inventive concept may be characterized by a transparent toner image being developed using a photosensitive body, an exposing unit, and a developing unit employed to develop color toners without employing an additional photosensitive body, an additional exposing unit, and an additional developing unit to develop the transparent toner image.

The transparent toner may be stored in a reservoir 47 of one of the developing units 21, 22, 23, and 24 together with a corresponding one of the color toners to form a toner composition. In addition, the transparent toner may be charged to an opposite polarity with respect to the polarity of the color toners. It is to be understood that the polarity of charge carried on the toner may not be measured with respect to 0V, but with respect to a non-zero reference potential. As such, the charge on each of the toners forming the toner composition in reservoir 47 may be negative with respect to 0V, but are of opposite polarity with respect to an intermediate potential between the charge of one of the toners in the toner composition and the charge on the other of the toners in the toner composition. For example, where a nonmagnetic mono-component toner is used, the color toners may be charged to a negative (−) polarity and the transparent toners may be charged to a positive (+) polarity with respect to an intermediate potential, as will be described below. The toner constituents forming the color toner may include a colorant to tint a binder resin, internal additives, such as a charge control agent (CCA), wax or the like, and external additives, such as silica and titanium oxide (TiO₂). The color toners may be charged to about −10 to −25 μC/g, as measured by a suction type Faraday Gauge, and a layer of the color toner on a developing roller 42 may be applied to about 0.5 to 1 mg/cm² in thickness. The toner constituents of the transparent toner may be similar to the constituents of the color toners, except for the colorant, the charge control agent (CCA) to adjust the level of charge on the transparent toner, and portions of the external additives.

For purposes of explanation and not limitation, the development of a latent image where the transparent toner is stored in the reservoir 47 of the developing unit 24 containing the yellow (Y) color toner will now be described.

To form an electrostatic latent image corresponding to the black (B) color image information, the exposing unit 31 scans light onto the photosensitive drum 11, which has been charged by the charging roller 41 to a uniform electric potential, in those regions where the black toner is to be applied. For example, the surface electric potential of the photosensitive drum 11 may be charged by the charging roller 41 to approximately −750V, as illustrated in FIG. 2. The electric potential of an image portion on which light from the second exposing unit 31 has impinged the photosensitive drum 11 may be approximately −50 V. A non-image portion in which light from the exposing unit 31 has not impinged the photosensitive drum 11 may be maintained to the electric potential of the original uniform surface charge of, for example, −750V. The intermediate electric potential between the electric potential of the image portion and the electric potential of the non-image portion may be applied as the developing bias voltage to each developing roller 42 of the developing unit 21. In the present exemplary embodiment, a developing bias voltage having the average electric potential of approximately −400 V is applied to the developing roller 42. Since the black toner is charged to a negative (−) polarity with respect to the developing bias, the black toner stored in the developing unit 21 is attracted to the image portion that has a positive (+) polarity with respect to the developing bias. A first transfer bias voltage having an opposite polarity to the charging polarity of the black toner is applied to the first transfer roller 71. As such, the black toner image developed on the photosensitive drum 11 is transferred by polar attraction onto the intermediate transfer belt 60.

The same operation as described above may be performed by the photosensitive drums 12, 13, and 14, the exposing units 32, 33, and 34, and the developing units 22, 23, and 24, respectively, at time intervals given by, for example, the formula (distance between photosensitive drums)/(carrying speed of intermediate transfer belt), so as to meet color registration requirements.

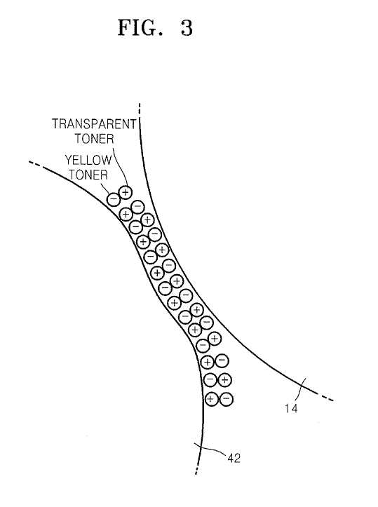

An exemplary operation of developing a transparent toner image will now be described. It will be assumed that the electric potentials of the image portion and the non-image portion of the photosensitive drum 14 exposed by the exposing unit 34 are identical with those illustrated in FIG. 2. A layer of toner comprised of a yellow toner and a transparent toner may be formed on the surface of the developing roller 42 of the developing unit 24, as illustrated in FIG. 3. To supply a sufficient amount of the yellow toner and the transparent toner to a developing region in which the developing roller 42 and the photosensitive drum 14 face each other, the thickness of the toner layer formed on the surface of the developing roller 42 may be larger than the toner layer of the developing roller 42 of other developing units 21, 22, and 23. To this end, pressure applied to the developing roller 42 by the regulating means 45 may be less than the pressure applied by the regulating means 45 of other developing units 21, 22, and 23. When the developing bias voltage is applied to the developing roller 42, the yellow toner and the transparent toner move to the photosensitive drum 14. The transparent toner may be charged to a positive (+) polarity with respect to the developing bias and the yellow toner may be charged to a negative (−) polarity with respect to the developing bias. Thus, the yellow toner on the surface of the developing roller 42 is attracted to the image portion and the transparent toner is attracted to the non-image portion. When a first transfer bias voltage is applied to the first transfer roller 74, the yellow toner image and the transparent toner image developed on the photosensitive drum 14 are transferred onto the intermediate transfer belt 60.

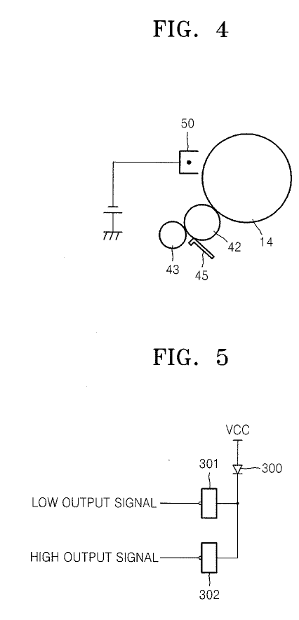

In order to improve the transfer efficiency of the yellow toner image and the transparent toner image from the photosensitive drum 14, the charging polarities of the two toner images may be made the same with respect to a transfer voltage before the toner images are transferred onto the intermediate transfer belt 60. For example, the charging polarity of the transparent toner image may be made the same as the charging polarity of the yellow toner image by an addition of charge thereon. To this end, a pre-transfer charging unit 50 is provided, as illustrated in FIGS. 1 and 4. The pre-transfer charging unit 50 charges the transparent toner image to the same negative (−) polarity with respect to the transfer voltage potential as the charging polarity of the yellow toner image by supplying a negative (−) charge to the toner images on the photosensitive drum 14. A first transfer bias voltage having a positive (+) polarity that is opposite to the polarities of the yellow and transparent toner images may be applied to the first transfer roller 74 to attract both images to the intermediate transfer belt 60. As such, the transfer efficiency of the yellow toner image and the transparent toner image is improved.

Through the above-described exemplary operations, the toner images of black (B), magenta (M), cyan (C), and yellow (Y), and the transparent (T) toner image are formed on the intermediate transfer belt 60. Upon the toner images reaching a region of the image forming apparatus where the second transfer roller 75 and the intermediate transfer belt 60 face each other, the printing medium supplied from the paper feeding cassette 91 reaches the region. A second transfer bias voltage having an opposite polarity to the charging polarities of the toner images is applied to the second transfer roller 75. Then, the toner images are transferred to the printing medium. As the printing medium passes through the fusing unit 92, the toner images are fused on the printing medium, such as by heat and pressure, and the printing operation is ended.

The color toner images printed through the above-described operations are images to which the transparent toner is attached to all regions in which the yellow toner image is not attached. Thus, the gloss of a background region in which the black (B), magenta (M), cyan (C), and yellow (Y) toner images are not attached is improved and the gloss of a region in which the black (B), magenta (M), and cyan (C) color toner images are attached is also improved. In this the image forming apparatus according to certain embodiments of the present general inventive concept, the transparent toner image can be developed without using an additional photosensitive body, an additional exposing unit, and an additional developing unit to develop the transparent toner image. Thus, a low-priced and miniaturized image forming apparatus employing the transparent toner image can be implemented. In addition, a difference in gloss of the printed image between the region in which the black (B), magenta (M), cyan (C), and yellow (Y) toner images are attached and the background region can be reduced so that the quality of the printed image is improved.

In the above-described exemplary embodiments, the exposing unit 34 implements two-level (on-off) exposure of the image portion and the non-image portion. The case where the exposure unit 34 performs tri-level exposure will now be described.

Tri-level exposure is a technique in which regions on the photosensitive drum are charged to one of three levels when exposure is performed. For example, the exposure output of the exposing unit 34 may be regulated to three distinct levels such as high output, low output, and off. FIG. 5 illustrates an example of a very simple control circuit to realize tri-level exposure for purposes of explanation and not limitation, as many other circuits to implement tri-level exposure may be used with the present general inventive concept without departing from the spirit and intended scope thereof. A laser diode 300 can be controlled into a high output state and a low output state using two laser drivers 301 and 302 that operate in response to a high-output exposure signal and a low-output exposure signal, respectively. When the signals to the two laser drivers 301 and 302 are both inactive, the laser diode 300 is turned off.

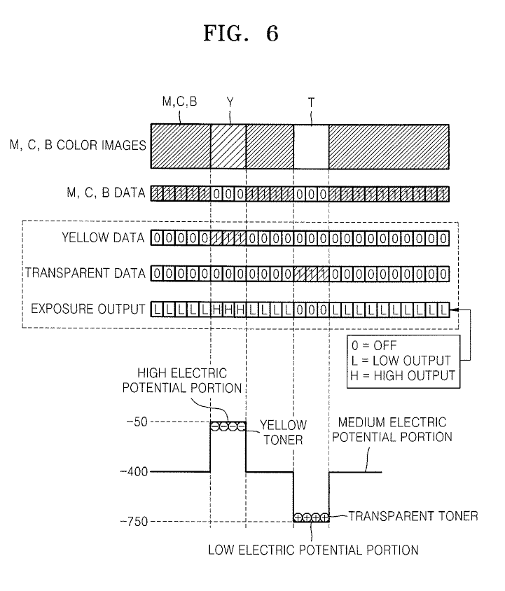

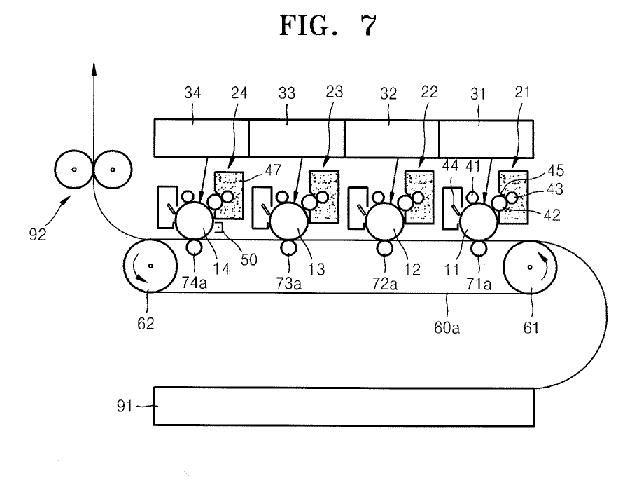

By tri-level exposure, a high electric potential portion, a medium electric potential portion, and a low electric potential portion may be formed on the surface of the photosensitive drum 14, as illustrated in FIG. 6. In certain embodiments of the present general inventive concept, the photosensitive drum 14 is charged to a negative (−1) polarity, and the high electric potential portion is one exposed by high-output light, the medium electric potential portion is one exposed by low-output light, and the low electric potential portion is an unexposed portion. Referring to FIG. 6, when yellow data is set, e.g., through a data value of “1”, the exposure output of the exposing unit 34 is controlled into a high output state H, and when black (B), magenta (M), and cyan (C) data are “1”, the exposure output of the exposing unit 34 is controlled into a low output state L. When black (B), magenta (M), cyan (C), and yellow (Y) data are reset, e.g., through a data value of “0”, transparent data is “1” and the exposing unit 34 is turned off.

Since the intermediate voltage of the developing bias voltage is between a voltage of the high electric potential portion and a voltage of the low electric potential portion, for example, −400 V, a yellow toner charged to a negative (−) polarity with respect to the intermediate voltage is attracted to the high electric potential portion and a transparent toner charged to a positive (+) polarity with respect to the intermediate voltage is attracted to the low electric potential portion. Neither the yellow toner nor the transparent toner is attracted to the medium electric potential portion. Thus, the transparent toner is attracted to only the background region in which the foreground regions of the black (B), magenta (M), cyan (C), and yellow (Y) toners are not attracted. In this way, the transparent toner is developed in the background region so that a difference in gloss between the foreground region, i.e., the areas in which the black (B), magenta (M), cyan (C), and yellow (Y) toners are attached, and the background region of the printed image can be reduced and the quality of the printed image can be improved.

In addition, in order to reduce a difference in gloss between a portion in which a high concentration of toner in an image is printed and a portion in which a low concentration of toner is in the image is printed, the area of the medium electric potential portion can be controlled. That is, even in regions where the black (B), magenta (M), and cyan (C) toners are developed, when the amount of the developed toners is small, the gloss of the portion is lowered. In those regions where the amount of the developed black (B), magenta (M), and cyan (C) toners is small, the exposing unit 34 may be turned off so that the low electric potential portion (not the medium electric potential portion) can be formed so that the transparent toner will be attracted thereto.

The above-described technique to develop the transparent toner may also be applied to a single pass image forming apparatus employing a direct transfer technique in which the toner image is directly transferred to the printing medium without an intermediate transfer operation, as illustrated in FIG. 7. Referring to FIG. 7, the printing medium withdrawn from the paper feeding cassette 91 is carried by a carrying belt 60a. Each of the transfer rollers 71a, 72a, 73a, and 74a faces each of the photosensitive drums 11, 12, 13, and 14 and the printing medium is conveyed on the carrying belt 60a therebetween. The transparent toner image and the color toner images respectively developed on the photosensitive drums 11, 12, 13, and 14 are directly transferred to the printing medium by a transfer bias voltage applied to each of the transfer rollers 71a, 72a, 73a, and 74a.

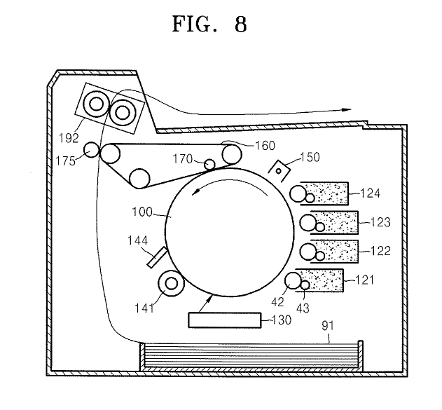

The above-described technique to develop the transparent toner may also be applied to a multiple pass image forming apparatus. FIG. 8 illustrates an electrophotographic image forming apparatus according to another embodiment of the present general inventive concept. The exemplary electrophotographic image forming apparatus illustrated in FIG. 8 is a multiple pass image forming apparatus, which comprises a photosensitive drum 100, an exposing unit 130, and four developing units 121, 122, 123, and 124. Referring to FIG. 8, the four developing units 121, 122, 123, and 124 are disposed around the photosensitive drum 100. Color toners such as black (B), magenta (M), cyan (C), and yellow (Y) are maintained in the four developing units 121, 122, 123, and 124, respectively, and a transparent toner may be stored in the developing unit 124 together with, for example, the yellow toner. The transparent toner may be charged to an opposite polarity with respect to the polarity of the yellow toner as measured against an intermediate potential. The image forming apparatus according to the exemplary embodiment may use a non-contact developing technique in which the developing roller 42 is separated from the photosensitive drum 100 by a developing gap. A contact developing technique in which the developing roller 42 is in contact with the photosensitive drum 100 may also be employed. In this case, each of the four developing units 121, 122, 123, and 124 may be sequentially in contact with or separated from the photosensitive drum 100. Even when the non-contact developing technique is employed, each of the four developing units 121, 122, 123, and 124 may sequentially face the photosensitive drum 100. As an example, the four developing units 121, 122, 123, and 124 may be installed on a rotating turret (not illustrated), and as the turret is rotated, each of the four developing units 121, 122, 123, and 124 sequentially faces the photosensitive drum 100 so that a developing operation can be performed. In addition, the four developing units 121, 122, 123, and 124 may be moved by using an actuator (not illustrated) and may also sequentially face the photosensitive drum 100. It is to be understood that the present general inventive concept is not limited by the configuration of developer components and that many developing mechanisms may be used with the present general inventive concept without departing from the spirit and intended scope thereof.

The exposing unit 130 may scan light onto the photosensitive drum 100, which may have been charged by a charging roller 141 to a uniform electric potential, according to, for example, black (B) image information to form thereby an electrostatic latent image corresponding to black (B) on the surface of the photosensitive drum 100. When the black (B) toner is supplied to the electrostatic latent image by the developing unit 121, a black toner image is formed on the surface of the photosensitive drum 100. The black toner image is transferred onto the intermediate transfer belt 160 by the first bias voltage applied to the first transfer roller 170. A cleaning blade 144 eliminates the black toner that remains on the photosensitive drum 100. When the black toner image which corresponds to a sheet of paper is transferred onto the intermediate transfer belt 160, toner images of magenta (M) and cyan (C) colors are sequentially transferred onto the intermediate transfer belt 160 through the similar operations.

Next, the exposing unit 130 may scan light onto the photosensitive drum 100, which may have been charged by a charging roller 141 to a uniform electric potential, according to yellow (Y) image information, for example, to form thereby an electrostatic latent image corresponding to yellow (Y) on the surface of the photosensitive drum 100. The yellow toner is attracted to the image portion of the electrostatic latent image and the transparent toner is attracted to the non-image portion. A pre-transfer charging unit 150 may change the charging polarity of the transparent toner image into the same charging polarity of the yellow toner image with respect to a transfer voltage. The yellow toner image and the transparent toner image are transferred onto the intermediate transfer belt 160 by the first transfer bias voltage applied to the first transfer roller 170. As such, color toner images are formed on the intermediate transfer belt 160. The color toner images are transferred to the printing medium using a second transfer roller 175 and are fused in a fusing unit 192 so that color images having improved gloss can be printed.

The exposing unit 130 may be a tri-level exposing unit. In this case, when electrostatic latent images of black (B), magenta (M), and cyan (C) colors are formed, two-level exposure is performed, and only when an electrostatic latent image of yellow (Y) color is formed, tri-level exposure is performed.

The exemplary embodiments above realize a toner composition of yellow toner and transparent toner that is stored in the reservoir 47 of same developing unit 24 or 124. However, the scope of the present general inventive concept is not limited to this. The toner composition may include black (B), magenta (M) or cyan (C) color toner constituents. Further, the scope of the present general inventive concept is not limited by the above-described developing sequence of black (B), magenta (M), cyan (C), and yellow (Y) toners. In addition, only the image forming apparatus employing a plurality of developing units has been described in the above-described embodiments. However, the scope of the present general inventive concept is also not limited to this. The present general inventive concept may also be applied to a single color image forming apparatus employing one developing unit to developing a single color image. In this case, the transparent toner is accommodated in the developing unit together with a single color toner.

As described above, in the electrophotographic image forming apparatus according to the present general inventive concept, the transparent toner image can be developed using an exposing unit, a photosensitive body, and a developing unit which are used to develop color toner images. Thus, a simple and low-priced electrophotographic image forming apparatus which improves gloss of a printed image can be implemented. In addition, the area of a medium electric potential portion of tri-level exposure is controlled such that gloss of the printed image is made uniform.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic image forming apparatus comprising:
a plurality of photosensitive bodies, each of which to be charged to a uniform electric potential;
a plurality of exposing units to form respective electrostatic latent images on the plurality of the photosensitive bodies;
a plurality of developing units to store respective different color toners to develop the electrostatic latent images on the plurality of the photosensitive bodies; and
a transparent toner stored in one of the plurality of the developing units together with a corresponding one of the color toners and charged to an opposite polarity with respect to a polarity of the color toners.

2. The apparatus of claim 1, further comprising:
a pre-transfer charging unit to charge to the same polarity the color toners and the transparent toner developed on the photosensitive body corresponding to the developing unit in which the one of the color toners and the transparent toner are stored.

3. The apparatus of claim 2, wherein the pre-transfer charging unit charges the charging polarity of the transparent toner to the same polarity as the charging polarity of the color toners.

4. The apparatus of claim 1, wherein the exposing unit to expose the photosensitive body corresponding to the developing unit in which the one of the color toners and the transparent toner are stored is a tri-level exposing unit having a three-level exposure output.

5. An electrophotographic image forming apparatus comprising:
a photosensitive body to be charged to a uniform electric potential;
an exposing unit forming an electrostatic latent image on the photosensitive body;
a plurality of developing units in which different color toners are stored to develop the electrostatic latent image on the photosensitive body;
a transfer medium to which a plurality of toner images sequentially developed on the photosensitive body are sequentially transferred; and
a transparent toner stored in one of the plurality of the developing units together with the corresponding one of the color toners and charged to an opposite polarity with respect to a polarity of color toners.

6. The apparatus of claim 5, further comprising:
a pre-transfer charging unit charging the color toners and the transparent toner developed on the photosensitive body to the same polarity prior to being transferred to the transfer medium.

7. The apparatus of claim 6, wherein the pre-transfer charging unit charges the charging polarity of the transparent toner to the same polarity as the charging polarity of the color toners.

8. The apparatus of claim 5, wherein the exposing unit is a tri-level exposing unit having a three-level exposure output.

9. An electrophotographic image forming apparatus comprising:
a photosensitive body to be charged to a uniform electric potential;
an exposing unit to form an electrostatic latent image on the photosensitive body;
a developing unit to develop the electrostatic latent image on the photosensitive body by supplying thereto color toners and a transparent toner charged to an opposite polarity with respect to a polarity of the color toners.

10. The apparatus of claim 9, further comprising:
a pre-transfer charging unit charging the color toners and the transparent toner developed on the photosensitive body to the same polarity.

11. An electrophotographic image forming apparatus comprising:
an electrostatically chargeable medium to receive a latent image thereon having a first region at a first electric potential and a second region at a second electric potential; and
a toner composition having first toner constituents to carry a first electric charge and second toner constituents to carry a second electric charge, the first toner constituents being electrically attracted to the first region and the second toner constituents being attracted to the second region to form a developed image on the electrostatically chargeable medium.

12. The electrophotographic image forming apparatus of claim 11, further comprising:
an exposing unit to produce the latent image on the electrostatically chargeable medium about an intermediate potential so that the first electric potential is more positive than the intermediate potential and the second electric potential is more negative than the intermediate potential.

13. The electrophotographic image forming apparatus of claim 12, wherein the exposing unit is a tri-level exposing unit to charge the first region to the first electric potential, to charge the second region to the second electric potential, and a third region to a third electric potential.

14. The electrophotographic image forming apparatus of claim 13, wherein the third electric potential is the intermediate potential.

15. The electrophotographic image forming apparatus of claim 12, wherein the electrostatically chargeable medium includes a photosensitive material, and the exposing unit establishes at least the first electric potential through an application of light to the photosensitive material.

16. The electrophotographic image forming apparatus of claim 13, wherein the electrostatically chargeable medium includes a photosensitive material, and the exposing unit establishes at least the first electric potential and the third electric potential through an application of light to the photosensitive material.

17. The electrophotographic image forming apparatus of claim 16, wherein the exposing unit applies light to the first region at a power level greater than a power level applied to the third region.

18. The electrophotographic image forming apparatus of claim 11 further comprising:
a pre-transfer charging unit to charge the first toner constituents and the second toner constituents on the developed image to a like electric polarity with respect to an intermediate potential.

19. The electrophotographic image forming apparatus of claim 18 further comprising:
an intermediate transfer belt to receive the developed latent image as charged by the pre-charge transfer unit.

20. The electrophotographic image forming apparatus of claim 11 further comprising:
a charge roller to charge the electrostatically chargeable medium uniformly to the second electric potential prior to receiving the latent image.

21. The electrophotographic image forming apparatus of claim 11, wherein the second toner constituents form a transparent region on the developed image.

22. An electrophotographic image forming apparatus comprising:
a photosensitive medium to receive a latent image thereon having a first region and a third region at a first electric potential and a second region at a second electric potential;
a first developer unit having stored therein a toner composition having first toner constituents to carry a first electric charge and second toner constituents to carry a second electric charge, the first toner constituents being electrically attracted to the first region and the second toner constituents being attracted to the second region; and
a second developer unit having stored therein third toner constituents to be attracted to the third region to form a developed image on the electrostatically chargeable medium.

23. The electrophotographic image forming apparatus of claim 22, further comprising:
an exposing unit to produce the latent image on the electrostatically chargeable medium about an intermediate potential so that the first electric potential is more positive than the intermediate potential and the second electric potential is more negative than the intermediate potential, the exposing unit to charge the third region to the first electric potential subsequent to the toner composition being attracted to the first region and the second region.

24. The electrophotographic image forming apparatus of claim 23, wherein the exposing unit is a tri-level exposing unit to charge the first region to the first electric potential, to charge the second region to the second electric potential, and the third region to a third electric potential.

25. The electrophotographic image forming apparatus of claim 24, wherein the third electric potential is the intermediate potential.

26. The electrophotographic image forming apparatus of claim 23, wherein the electrostatically chargeable medium includes a photosensitive material, and the exposing unit establishes at least the first electric potential through an application of light to the photosensitive material.

27. The electrophotographic image forming apparatus of claim 24, wherein the electrostatically chargeable medium includes a photosensitive material, and the exposing unit establishes at least the first electric potential and the third electric potential through an application of light to the photosensitive material.

28. The electrophotographic image forming apparatus of claim 27, wherein the exposing unit applies light to the first region at a power level greater than a power level applied to the third region.

29. The electrophotographic image forming apparatus of claim 22 further comprising:
a pre-transfer charging unit to charge the first toner constituents and the second toner constituents on the developed image to a like electric polarity with respect to an intermediate potential.

30. The electrophotographic image forming apparatus of claim 22, wherein the second toner constituents form a transparent region on the developed image.

31. A toner cartridge comprising:
a toner reservoir; and
a toner composition retained in the toner reservoir and comprising:
first toner constituents to carry a first electric charge; and
second toner constituents to carry a second electric charge.
